(19) United States
(12) Patent Application Publication
(10) Pub. No.: US 2012/0322371 A1
(43) Pub. Date: Dec. 20, 2012

(54) MOBILE COMMUNICATION TERMINAL USING NEAR FIELD COMMUNICATION AND METHOD OF CONTROLLING THE SAME

(75) Inventor: Sang Hoon LEE, Gwanju (KR)

(73) Assignee: AQ CO., LTD., Seoul (KR)

(21) Appl. No.: 13/444,815

(22) Filed: Apr. 11, 2012

(30) Foreign Application Priority Data
Jun. 16, 2011 (KR) 10-2011-0058686

(51) Int. Cl. H04B 5/00

(52) U.S. Cl. 455/41.1

(57) ABSTRACT

Disclosed herein are a mobile communication terminal using Near Field Communication (NFC) and a method of controlling the same. The mobile communication terminal receives data from an NFC active tag during NFC communication. The mobile communication terminal includes an NFC antenna for receiving a data signal from the active tag, an NFC controller for performing control so that a session with the active tag is set up, and receiving the data signal, a function control unit for receiving the data signal from the NFC controller and analyzing the data signal, and a terminal control unit for performing functions of the mobile communication terminal. The data signal of the active tag is a function control signal including a command to control at least one function of the mobile communication terminal. The function control unit extracts the command, applies the command to the terminal control unit, and executes the command.

### CROSS REFERENCE TO RELATED APPLICATION AND CLAIM OF PRIORITY

The present application claims the benefit of Korean patent application No. 10-2011-0058686 filed in the Korean Intellectual Property Office on Jun. 16, 2011, the entire content of which is incorporated herein by reference.

### BACKGROUND OF THE INVENTION

1. Field of the Invention

The present invention relates generally to a mobile communication terminal using Near Field Communication (NFC) and a method of controlling the same.

2. Description of the Related Art

In general, mobile communication terminals include a variety of functions, such as a ringing function for alerting incoming calls, a communication function for wirelessly sending and receiving voice and data signals, a camera function for capturing still and moving images, an MP3 function for playing back music files, a recording function for recording and playing back audio signals, a scanning function for copying and recording documents, an electronic book function for reading recorded text information, a note function, and a data terminal function, as well as a communication function for communicating with a wired/wireless terminal. Recently, mobile communication terminals have developed into smart phones equipped with a wireless Internet access function. This trend is expected to continue.

In particular, with the rapid spread of mobile communication terminals, most people possess a mobile communication terminal. Meanwhile, NFC technology has been applied to such mobile communication terminals, so that wireless data communication has become possible at low power over a short range.

A method of making payments using such an NFC function like credit cards is referred to as non-contact payment. Means for processing such non-contact payments is smartcard means. Recently, mobile communication terminals are generally equipped with a smartcard function.

Meanwhile, there are cases where persons carry mobile communication terminals equipped with the above-described variety of functions into silence requiring places, such as a conference room, a class room and a library, and generate ring tones audibly indicative of incoming calls, thereby offending other persons or obstructing corresponding programs.

In such limited areas, it is necessary to operate mobile communication terminals in silent mode or vibrate mode in order to prevent audible ring tones from being output Furthermore, there are cases where in places (hereinafter referred to as the “security areas”) where high-cost, new technology-related research, development and production are performed, such as laboratories, development rooms and factories, important confidential information is captured, recorded and/or scanned using the camera function, recording function and/or scanning function of mobile communication terminals without permission and is then divulged to the outside or rapidly transmitted to remote locations using the communication function of the mobile communication terminals.

In such security areas, it is necessary to perform automatic control so that one or more selected specific functions, such as a camera function, a recording function, a data communication function, a voice communication function, a sound output function and a vibration output function are turned off so as to maintain security.

### SUMMARY OF THE INVENTION

Accordingly, at least one embodiment of the present invention has been made keeping in mind the above problems occurring in the prior art, and an object of the present invention is to provide a mobile communication terminal using NFC and a method of controlling the same, which enable the automatic mode switching of an active NFC tag and the mobile communication terminal, and receive a command to control at least one device of the mobile communication terminal (for example, a camera, a vibrating configuration, a ringing configuration, a message output configuration, a call forwarding configuration, a recording configuration, or a scanning configuration) from the active NFC tag via short distance communication between the active NFC tag and the mobile communication terminal and compulsorily controls the device of the mobile communication terminal.

According to an aspect of the present invention, an embodiment of the present invention provides a mobile communication terminal using Near Field Communication (NFC), the mobile communication terminal receiving data stored in an NFC active tag while performing NFC communication with the NFC active tag that can switch to any one of reader mode and card mode, the mobile communication terminal including an NFC antenna for receiving a data signal from the active tag; an NFC controller for performing control so that a session with the active tag is set up, and receiving the data signal from the active tag via the NFC antenna; a function control unit for receiving the data signal, sent by the active tag, from the NFC controller and analyzing the data signal; and a terminal control unit for performing functions of the mobile communication terminal; wherein the data signal of the active tag is a function control signal including a command to control at least one function of the mobile communication terminal; and wherein the function control unit extracts the command from the function control signal, applies the command to the terminal control unit, and executes the command included in the function control signal, thereby compulsorily controlling the function of the mobile communication terminal.

The NFC controller, if there is a match of ID information sent in response to an ID information request signal received from the active tag while operating in card mode, may switch to reader mode, set up the session with the active tag, receive the data from the active tag, and apply the data to the function control unit.

The active tag may include an ID information unit for storing ID information; memory for storing the command to control the function of the mobile communication terminal; a tag antenna for transmitting and receiving data to and from the mobile communication terminal in an NFC manner; and a tag controller for operating in reader mode, requesting ID information from the mobile communication terminal, checking the received ID information, switching to card mode if there is a match, and performing control so that the session with the mobile communication terminal is set up and the function control signal, including the command stored in the memory, is sent via the active tag antenna.

The memory may store at least one of a command to turn off the function of the mobile communication terminal, a command to turn on the function of the mobile communication terminal, and a command to turn off the function of the mobile communication terminal and then turn on the function after a predetermined time has elapsed.

According to an aspect of the present invention, an embodiment of the present invention provides a method of controlling a mobile communication terminal using NFC communication, the method receiving a command while performing NFC communication with an active tag storing ID information and the command to control at least one function of the mobile communication terminal and controlling the function, the method including an ID information request reception step of operating in card mode and receiving an ID information request signal from the active tag; a response step of sending stored ID information to the active tag in response to the ID information request signal; a session setup determination step of determining whether there is a match between the sent ID information and the ID information of the active tag and determining whether to set up a session; a reader mode switching step of setting up a session if there is a match at the session setup determination step, switching to reader mode, and receiving a function control signal from the active tag; a command extraction step of analyzing a function control signal received from the active tag and extracting a command to control a function of the mobile communication terminal; and a command execution step of executing the command extracted at the command extraction step, and controlling the function.

The command may include one or more of a command to turn off the function, a command to turn on the function, and a command to turn off the function and then turn on the function after a predetermined time has elapsed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a drawing illustrating an overview of a mobile communication terminal using NFC and a method of controlling the same according to an embodiment of the present invention;

FIG. 2 is a block diagram illustrating the configuration of the mobile communication terminal using NFC according to an embodiment of the present invention;

FIG. 3 is a block diagram illustrating the configuration of an active tag according to an embodiment of the present invention;

FIG. 4 is a flow diagram illustrating a method of controlling the mobile communication terminal using NFC according to an embodiment of the present invention;

FIG. 5 is a flowchart illustrating the active tag operating step of the method of controlling the mobile communication terminal using NFC according to an embodiment of the present invention; and

FIG. 6 is a flowchart illustrating the communication terminal operating step of the method of controlling the mobile communication terminal using NFC according to an embodiment of the present invention.

### DETAILED DESCRIPTION

Reference now should be made to the drawings, in which the same reference numerals are used throughout the different drawings to designate the same or similar components.

A mobile communication terminal using NFC and a method of controlling the same according to embodiments of the present invention will be described in detail below with reference to the accompanying drawings.

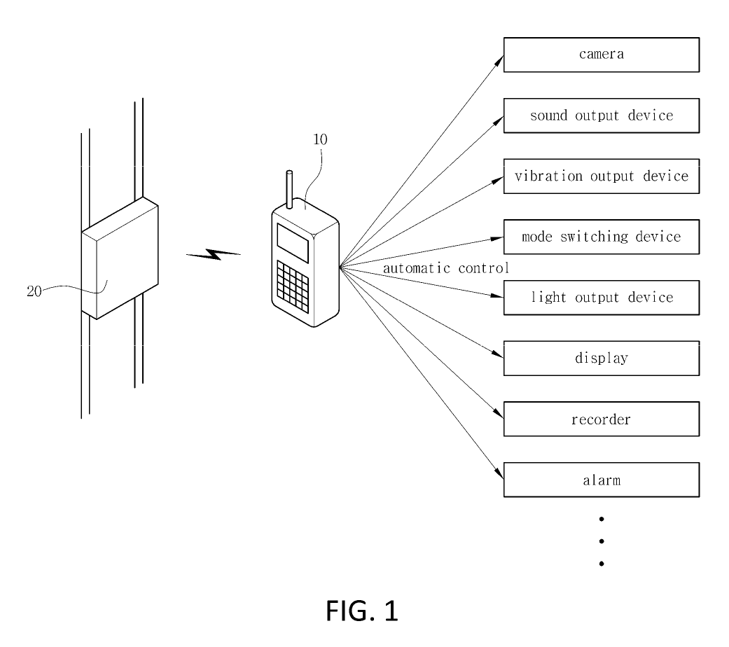

FIG. 1 is a drawing illustrating an overview of a mobile communication terminal 10 using NFC and a method of controlling the same according to an embodiment of the present invention.

Referring to FIG. 1, the control device of the mobile communication terminal 10 using NFC and the method of controlling the same according to an embodiment of the present invention enable automatic mode switching via communication between the mobile communication terminal 10 and an active tag 20 that communicate with each other using NFC, and enable the compulsory control of at least one function executed on the mobile communication terminal 10 while operating in the switched mode. Here, the mobile communication terminal 10 is any one of mobile communication terminals including, but not limited to, a mobile phone, a notebook computer, a smart phone, a Personal Digital Assistant (PDA), a Portable Multimedia Player (PMP), a netbook computer, and a tablet Personal Computer (PC) that are capable of NFC.

The active tag 20 can operate both in card mode and in reader mode. The active tag 20 sends stored data to the mobile communication terminal 10 in card mode, and reads data stored in the mobile communication terminal 10 in reader mode.

Accordingly, the active tag 20 operates in reader mode first, and when the mobile communication terminal 10 using NFC approaches the active tag, checks ID information, and automatically switches to card mode if the mobile communication terminal 10 has identical ID information. Thereafter, the active tag 20 sends a function control signal including a command to control at least one function of the mobile communication terminal 10. Here, the function control signal includes, for example, any one or more of a locking command to turn off at least one function of the mobile communication terminal 10, an unlocking command to turn on the function, and a locking and unlocking combined command to turn off a function and then turn on the function after a predetermined time.

That is, for example, the active tag 20 is installed in a theater, and switches to card mode via wireless communication when the mobile communication terminal 10 carried by a movie viewer approaches the active tag 20 while operating in reader mode, and sends the command to the mobile communication terminal 10 which operates in reader mode. Here, if the active tag 20 stores a locking command to turn off a sound output device, the mobile communication terminal 10 carried by the user reads the locking command from the active tag 20, and the sound output device is turned off.

Alternatively, if the active tag 20 stores a locking and unlocking combined command, the mobile communication terminal 10 turns off the sound output device when the user enters the theater, and turns on ring tones after a predetermined time has elapsed.

If the ID information of the active tag 20 is identical to the ID information of the active tag 20, the mobile communication terminal 10 automatically switches from card mode to reader mode, and reads the data stored in the active tag 20. The mobile communication terminal 10 includes a plurality of devices that implement the functions of the mobile communication terminal 10. For example, the mobile communication terminal 10 automatically controls any one of a camera, a scanner, a sound input and output device, a vibration output device, a display, a light output device, and data transmission and reception device in response to a function control command sent by the active tag 20.

The mobile communication terminal 10 is provided with the above-described devices, and performs a variety of functions such as communication with a wired/wireless terminal, the capturing of images, the recording and playback of sounds, scanning, the turning on and off of ring tone and vibration output, the switching of reception mode (between vibrate mode and ringer mode), the capture and playback of moving images, wireless Internet access, the transmission and reception of text, and voice communication (hereinafter collectively referred to as the “function”).

Here, examples of the sound output device and vibration output device include devices that control and turn off the volume of sound for incoming calls and call reception, that output vibrations and ringtones, and that control and turn off sound that is output upon switching from vibrate mode to ringer mode, recording and playing back, and touching a keypad.

Furthermore, examples of the light output device includes light emission devices that emit light and function as an illuminating device and that control the brightness of the display and keypad of the mobile communication terminal 10.

The data transmission and reception device is a device that performs wireless communication between mobile communication terminals 10. Examples of the data transmission and reception device include an infrared communication device and a Bluetooth device that enable wireless communication between terminals proximate to each other.

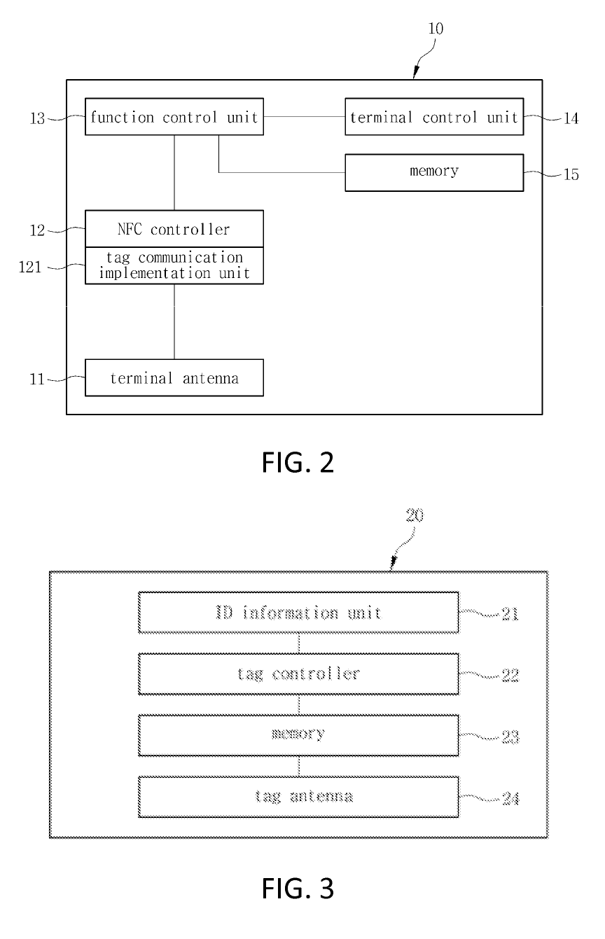

FIG. 2 is a block diagram illustrating the configuration of the mobile communication terminal using NFC according to an embodiment of the present invention.

Referring to FIG. 2, the mobile communication terminal 10 using NFC according to an embodiment of the present invention automatically switches to reader mode when there is a match of ID information with the active tag 20 in card mode for providing data, and performs one-to-one NFC communication with the active tag 20. For this purpose, the mobile communication terminal 10 includes an antenna 11 for receiving a data signal in the frequency band of, for example, 13.56 MHz within a short distance of, for example, about 10 centimeters, an NFC controller 12 for controlling automatic mode switching from card mode and performing NFC wireless communication with the active tag 20 via the antenna 11, a function control unit 13 for reading a command from a function control signal received by the NFC controller 12 and applying the command to a terminal control unit 14 for controlling a mounted device, the terminal control unit 14 for executing and turning off the corresponding function of the mobile communication terminal 10, and memory 15 for recording and storing the received function control signal.

The antenna 11 receives a signal from the active tag 20 within a short distance of 10 centimeters and applies the signal to the NFC controller 12, and sends a transmission signal, applied by the NFC controller 12, to the active tag 20.

The NFC controller 12 includes a tag communication implementation module 121 that requests and checks the ID information of the active tag 20. Here, the ID information (applet identifier (AID) information) is information that is used to identify a unique applet based on data format. Furthermore, the NFC controller 12 controls automatic switching from card mode to reader mode when NFC communication with the active tag 20 having the matched ID information is performed, and receives the data of the active tag 20 via the tag communication implementation module 121.

The NFC controller 12 is configured such that when it is located proximate to the active tag 20, the tag communication implementation module 121 runs, requests the ID information from the active tag 20, confirms that their data formats are the same, and then performs wireless communication with the active tag 20.

The terminal control unit 14 performs the turning on and off of one or more functions that are implemented in the mobile communication terminal 10. For example, the terminal control unit 14 performs turning on and off of one or more devices, such as a camera, a power source unit, a recorder, a player, a vibration output device, a sound output device, a display and a light output device, which are mounted in the mobile communication terminal 10.

The memory 15 temporarily stores the function control signal received from the active tag 20 so that the function control unit 13 can read the command therefrom.

The function control unit 13 analyzes the function control signal recorded in the memory 15, reads the command to control one or more functions, and applies the command to the terminal control unit 14. For example, the function control unit 13 analyzes which of the functions, including the turning off of a camera, switching to vibrate mode, the control of the brightness of a display, ring tone output, the turning off of a recorder, and the turning off of a speaker, is executed by the command, and applies the results of the analysis to the terminal control unit 14. Furthermore, the function control unit 13 performs control so that the execution of the terminal control unit 14 and the results of the execution are output via a display in the form of text.

FIG. 3 is a block diagram illustrating the configuration of the active tag 20 according to an embodiment of the present invention.

Referring to FIG. 3, the active tag 20 according to an embodiment of the present invention includes an ID information unit 21 for storing ID information, memory 23 for storing a command to control at least one function of the mobile communication terminal 10, a tag controller 22 for performing control so that a function control signal including the ID information stored in the ID information unit 21 and the command stored in the memory 23 is sent to the mobile communication terminal 10 while performing NFC communication with the mobile communication terminal 10, and a tag antenna 24 for sending the signal applied by the tag controller 22.

Of these components, the memory 23 stores at least one command to control at least one function of the mobile communication terminal 10. In greater detail, the command may be, for example, a locking command such as “A function OFF,” “B function OFF,” or “C function OFF,” an unlocking command such as “A function ON,” “B function ON,” or “C function ON,” or an unlocking-after-locking command such as “A function OFF and then A function ON after 2 hours.”

The tag controller 22 controls switching from reader mode to card mode, thereby controlling NFC communication with the mobile communication terminal 10. Here, the tag controller 22, if the mobile communication terminal 10 is situated at a proximate location while the mobile communication terminal 10 operates in reader mode, requests ID information from the mobile communication terminal 10, checks received ID information, switches to card mode if there is a match of the ID information, and performs control so that a session with the mobile communication terminal 10 is set up and a function control signal including the command stored in the memory 23 is sent via the tag antenna 24.

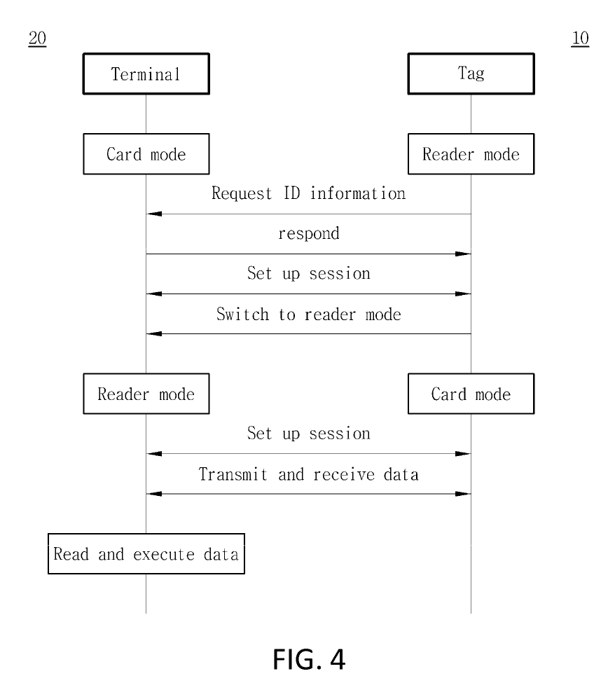

The mobile communication terminal 10 using NFC according to an embodiment of the present invention includes the active tag 20 and the mobile communication terminal 10. A method of controlling the mobile communication terminal 10 using NFC, which is performed using the above-described configuration, will be described in detail below with reference to FIGS. 4 to 6.

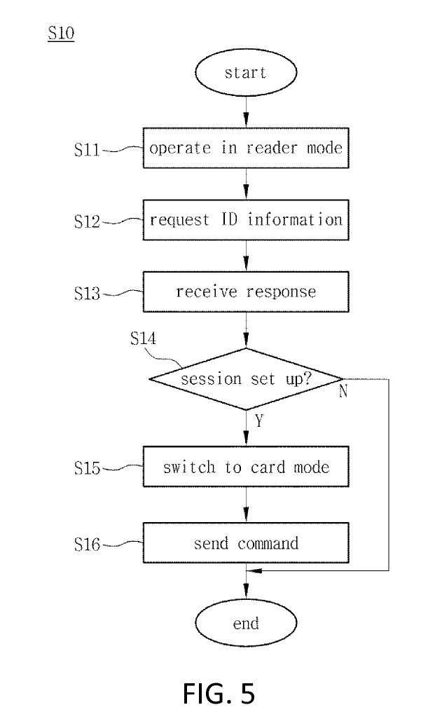

FIG. 4 is a flow diagram illustrating the method of controlling the mobile communication terminal 10 using NFC according to an embodiment of the present invention, and FIG. 5 is a flowchart illustrating the active tag operating step of the method of controlling the mobile communication terminal 10 using NFC according to an embodiment of the present invention.

Referring to FIGS. 4 and 5, the method of controlling the mobile communication terminal 10 using NFC according to an embodiment of the present invention includes tag operating step S10 of operating the tag 20 that stores ID information and a command to control at least one function of a device mounted in the mobile communication terminal 10 and sends the data to the mobile communication terminal 10, and communication terminal operating step S20 of performing NFC communicating with the active tag 20 and controlling the function of the device in compliance with the function control command.

Referring to FIG. 5, the step of operating the active tag 20 includes reader mode operation step S11 of operating in reader mode, ID information request step S12 of requesting ID information from the mobile communication terminal 10, response reception step S13 of receiving a response from the mobile communication terminal 10, session setup determination step S14 of analyzing the response received at the response reception step S13 and determining whether to set up a session by analyzing whether there is a match of the ID information, card mode switching step S15 of switching to card mode if it is determined the session with the mobile communication terminal 10 will be set up, and command transmission step S16 of sending a function control signal including the command control the command of the mobile communication terminal 10.

The reader mode operation step S11 is the step of operating in reader mode in which the tag controller 22 reads the data of the mobile communication terminal 10 via the tag antenna 24 at a proximate location.

The ID information request step S12 is a step at which the tag controller 22 requests ID information if the mobile communication terminal 10 using NFC is situated at a proximate location while the active tag controller 22 is operating in reader mode at the reader mode operation step S11. Here, the active tag 20 request ID information via the tag antenna 24.

The response reception step S13 is a step at which the tag controller 22 receives the ID information from the mobile communication terminal 10 via the tag antenna 24.

The session setup determination step S14 is a step at which the tag controller 22 compares the ID information included in the response of the mobile communication terminal 10 received via the tag antenna 24 with its own stored ID information, sets up a session if there is a match, and terminates communication if there is no match.

The card mode switching step S15 is a step at which the tag controller 22 switches from reader mode to card mode to send the stored data if, as a result of the determination at the session setup determination step S14, there is a match of the ID information with the mobile communication terminal 10 and a session is set up to enable communication between both sides.

The command transmission step S16 is a step at which the tag controller 22 sends a function control signal including at least one command stored in the memory 23 to the mobile communication terminal via the tag antenna 24.

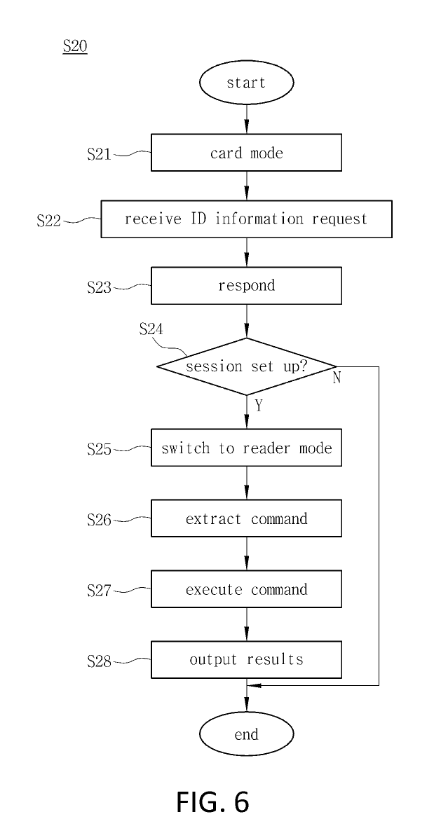

FIG. 6 is a flowchart illustrating the communication terminal operating step of the method of controlling the mobile communication terminal using NFC according to an embodiment of the present invention.

Referring to FIG. 6, step S20 of operating the mobile communication terminal 10 includes card mode operation step S21, ID information request reception step S22 of receiving an ID information request from the active tag 20, response step S23 of sending its own ID information in response to the ID information request, session setup determination step S24 of determining whether a session with the active tag 20 has been set up, reader mode switching step S25 of switching to reader mode if a session with the active tag 20 has been set up, command extraction step S26 of, after the reader mode switching step S25, receiving a function control signal from the active tag 20 and extracting a command from the function control signal, command execution step S27 of applying the command, extracted at the command extraction step S26, to the extracted terminal control unit 14, thereby executing the command, and result output step S28 of outputting the results of the execution of the command, obtained at the command execution step S27, via the display.

The card mode operation step S21 is a step at which the mobile communication terminal 10 operates in card mode under the control of the NFC controller 12 if a data request is made by the active tag 20.

The ID information request reception step S22 is a step at which the NFC controller 12 receives an ID information request signal from the active tag 20 via the antenna 11.

The response step S23 is a step at which the NFC controller 12 sends its own ID information to the active tag 20 via the antenna 11.

The session setup determination step S24 is a step at which the NFC controller 12 compares two pieces of ID information of both sides, and determines whether to set up a session if there is a match.

The reader mode switching step S25 is a step at which the NFC controller 12 switches reader mode to read data from the active tag 20 if a session with the active tag 20 is set up after the session setup determination step S24.

The command extraction step S26 is a step at which the NFC controller 12 temporarily stores the function control signal, received from the active tag 20, in the memory 15, the function control unit 13 analyzes the function control signal stored in the memory 15, and extracts a command from the function control signal. Here, the data received from the active tag 20 is a function control signal including a command to control at least one function that is implemented in the mobile communication terminal 10. Accordingly, the function control unit 13 analyzes the function control signal recorded in the memory 15 via the NFC controller 12, and extracts the corresponding command. Here, the function control signal recorded in the memory 15 is encrypted. Accordingly, the function control unit 13 decrypts the function control signal encrypted and recorded in the memory 15, and then extracts the command.

The command execution step S27 is a step at which the function control unit 13 applies the command, extracted by analyzing the function control signal recorded in the memory 15, to the terminal control unit 14, thereby executing the corresponding function of the mobile communication terminal 10. Accordingly, the terminal control unit 14 executes the command applied by the function control unit 13. Here, the command is any one of locking command “A function OFF,” unlocking command “A function ON” and unlocking-after-locking command “A function OFF and then A function ON after a predetermined time.”

The result output step S28 is a step at which the function control unit 13 outputs the function and the results of the execution of the function, performed at the command execution step S27, via the display of the mobile communication terminal 10. For example, when a camera is turned off by compulsory control at the command execution step S17, the function control unit 13 outputs the text message “camera has been turned off” via the display.

As described above, one or more of the embodiments of the present invention are configured to enable the automatic switching of the active tag 20 and the mobile communication terminal 10 between card mode and reader mode and then perform NFC communication. Furthermore, one or more of the embodiments of the present invention are configured to store a command to control at least one function of the mobile communication terminal 10 in the active tag 20 and cause the command to be executed in the mobile communication terminal 10, so that it can be widely utilized because the use of the mobile communication terminal 10 can be prevented from inconveniencing the general public and secrets are prevented from being divulged at a place requiring security. Furthermore, the present invention is configured to enable the overall process to be automatically performed without requiring a user's manipulation or other settings, and therefore it is very convenient in terms of use.

The above-described characteristics of the embodiments of the present invention may be modified in a variety of ways by service providers, designers and vendors, and may be practiced in ways that have not been set forth in the above description. According to the embodiments of the present invention, the one or more active tags 20 and the mobile communication terminal 10 that can perform NFC wireless communication are provided and the functions of the mobile communication terminal 10 can be compulsorily controlled by the active tags 20. Therefore, although variations and modifications have not been described in the above description, they should be interpreted as falling within the scope of the claims as long as they are within the range of the above-described technical spirit.

As described above, one or more of the embodiments of the present invention has the advantage of providing a user's convenience because the active tag and the mobile communication terminal which are capable of NFC can automatically switch from card mode to reader mode. The present invention provides the advantage of preventing the use of mobile communication terminals from inconveniencing surrounding people at specific places, such as movie theaters, parks, buses and public bath houses, and the advantage of preventing information from being divulged at security requiring places such as laboratories or public offices because control can be performed via communication with the NFC tag so that the functions of the mobile communication terminal are limited depending on the characteristics of places. The present invention has the advantage of providing a user's convenience because mode switching and function control are automatically performed without the user's manipulation.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. A mobile communication terminal using Near Field Communication (NFC), the mobile communication terminal receiving data stored in an NFC active tag while performing NFC communication with the NFC active tag that can switch to any one of reader mode and card mode, the mobile communication terminal comprising:
an NFC antenna for receiving a data signal from the active tag;
an NFC controller for performing control so that a session with the active tag is set up, and receiving the data signal from the active tag via the NFC antenna;
a function control unit for receiving the data signal, sent by the active tag, from the NFC controller and analyzing the data signal; and
a terminal control unit for performing at least one function of the mobile communication terminal;
wherein the data signal of the active tag is a function control signal including a command to lock or unlock the at least one function of the mobile communication terminal; and
wherein the function control unit extracts the command from the function control signal, applies the command to the terminal control unit, and executes the command included in the function control signal, thereby compulsorily controlling the function of the mobile communication terminal.

2. The mobile communication terminal of claim 1, wherein the NFC controller, if there is a match of ID information sent in response to an ID information request signal received from the active tag while operating in the card mode, switches to the reader mode, sets up the session with the active tag, receives the data from the active tag, and applies the data to the function control unit.

3. The mobile communication terminal of claim 1, wherein the active tag comprises:
an ID information unit for storing ID information;
a memory for storing the command to control the function of the mobile communication terminal;
a tag antenna for transmitting and receiving data to and from the mobile communication terminal in an NFC manner; and
a tag controller for operating in reader mode, requesting ID information from the mobile communication terminal, checking the received ID information, switching to card mode if there is a match, and performing control so that the session with the mobile communication terminal is set up and the function control signal, including the command stored in the memory, is sent via the active tag antenna.

4. The mobile communication terminal of claim 3, wherein the memory comprises a plurality of commands to lock or unlock the at least one function of the mobile communication terminal; and
the function control unit individually or simultaneously locks or unlocks one or more functions via one or more commands selected from among the plurality of commands.

5. A method of controlling a mobile communication terminal using NFC communication, the method receiving a command while performing NFC communication with an active tag storing ID information and the command to control at least one function of the mobile communication terminal and controlling the function, the method comprising:
an ID information request reception step of operating in card mode and receiving an ID information request signal from the active tag;
a response step of sending stored ID information to the active tag in response to the ID information request signal;
a session setup determination step of, after the response step, determining whether there is a match between the sent ID information and the ID information of the active tag and determining whether to set up a session;
a reader mode switching step of setting up a session if there is a match at the session setup determination step, switching to reader mode, and receiving a function control signal from the active tag;
a command extraction step of analyzing the function control signal received from the active tag and extracting the command to control a function of the mobile communication terminal;
a command execution step of executing the command extracted at the command extraction step, and controlling the function;
wherein the function control signal of the active tag is a function control signal including a command to lock or unlock at least one function of the mobile communication terminal; and
wherein the command is extracted from the function control signal, and the command included in the function control signal is executed, thereby compulsorily controlling the function of the mobile communication terminal.

6. The method of claim 5, wherein the command comprises a plurality of commands to lock and unlock a plurality of functions of the mobile communication terminal; and
one or more functions are individually or simultaneously locked or unlocked via one or more commands selected from among the plurality of commands of the function control signal.

7. The method of claim 6, wherein the command comprises a command to lock one or more functions of the mobile communication terminal and then unlock them after a predetermined time has elapsed.

8. The mobile communication terminal of claim 4, wherein the memory further comprises a command to lock one or more functions of the mobile communication terminal and then unlock them after a predetermined time has elapsed.
